(19) United States
(12) Patent Application Publication
(10) Pub. No.: US 2005/0284185 A1
(43) Pub. Date: Dec. 29, 2005

(54) Optical fiber producing method and producing device, and cleaning device

(75) Inventors: Yuji Abe, KANAGAWA (JP); Koh Chiba, Kanagawa (JP); Nobuya Akaike, Kanagawa (JP); Hiroshi Hori, Kanagawa (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD., OSAKA (JP)

(21) Appl. No.: 10/531,066

(22) PCT Filed: Apr. 20, 2004
(86) PCT No.: PCT/JP04/05671

§ 371 Date: Apr. 12, 2005

(30) Foreign Application Priority Data
Apr. 23, 2003 (JP) 2003-118445

(51) Int. Cl. C03B 37/00; C03B 37/04

(52) U.S. Cl. 65/503

(57) ABSTRACT

There is disclosed a method and apparatus for producing an optical fiber which is capable of producing the optical fiber having a high reliability by directly wiping the surface of the optical fiber with cleaning means for positively removing foreign materials adhered to or precipitated on the surface of the optical fiber and in which its facility is simple in structure and easy to maintain it. A cleaning member (11) is disposed on an optical fiber moving path. The surface of moving optical fiber (20) is cleaned by bringing the optical fiber (20) into a physical contact with the cleaning member (11). The cleaning member (11) can be formed of a porous or mesh member. The mesh member is formed of fiber sheets which are formed by knitting fiber threads. A plurality of the fiber sheets are laminated to provide a given lamination thickness for the cleaning length of the optical fiber (20). The optical fiber is passed through the cleaning member (11) prior to detection of uneven spots on the optical fiber or coloring of the optical fiber (20).

### TECHNICAL FIELD

The present invention relates to a method and apparatus for producing an optical fiber which is subjected to a cleaning process to remove foreign materials such as dusts and particles adhered to the surface of the optical fiber or precipitated thereon and an apparatus for cleaning the optical fiber.

### BACKGROUND OF THE INVENTION

On production of optical fibers, the mechanical strength is usually enhanced by applying a protective coating on a glass fiber which has just drawn from an optical fiber matrix. Subsequent to the application of the protective coating, a second coating may be applied to the glass fiber to further enhance the strength or a colored layer may be formed on the surface of the glass fiber by applying a coloring paint thereon according to a form of use of the optical fiber. After application of the protective coating on the glass fiber, the coated glass fiber is taken up on a reel and measurement of the length of the optical fiber is conducted for dividing it into optical fibers having a given length for rewinding. In addition, at a later date, secondary coating may be applied or coloring is conducted for the optical fiber, or a plurality of optical fibers may be bundled and integrated into a tape, core or cable by a common coating.

Particularly in case in which the optical fiber to which a protective coating has been applied is taken up on a reel and is then coated with a secondary coating, the optical fiber is liable to be electrostatically charged to readily attract refuse such as dusts and particles since the optical fiber is dielectric. If next coating is formed on the surface of the optical fiber on which refuse adheres, an adverse effect is given to the signal transmission characteristics of the optical fiber or lowering of the strength of the optical fiber or separation of the colored layer may occur. In order to prevent these adverse effects from occurring, a technique for removing foreign materials such as refuse adhered to the surface of an optical fiber by passing the moving optical fiber through a through-hole which is in the form of tapered nozzle and by blowing a gas into the through-hole is disclosed in the Patent Document 1.

A technique for bringing the coated optical fiber into contact with an atmosphere containing a material which is capable of carrying electrostatic charges caused by combustion (molecules of water, ammonia, hydrogen chloride, sulfur dioxide and activated molecules thereof) is disclosed in Patent Document 2. By performing this processing, removal of electrostatic charges on the optical fiber and prevention of accumulation of electrostatic charges is achieved, so that adhering of foreign materials such as refuse on the optical fiber can be prevented.

A technique for preventing a color layer from being separated from the optical fiber surface by managing the time interval between winding of the optical fiber to which a first protective coating is applied, and coloring on the optical fiber surface is disclosed in Patent Document 3.
Patent Document 1: Japanese Laid-Open Patent Publication No. H05-11155
Patent Document 2: Japanese Laid-Open Patent Publication No. H10-194791
Patent Document 3: Japanese Laid-Open Patent Publication No. H09-268033

### DISCLOSURE OF THE INVENTION

Removal of foreign materials adhered to the optical fiber surface is conducted by blowing a gas toward the optical fiber in the technique disclosed in Patent Document 1. This technique is able to remove the foreign materials if they are relatively lightly adhered to the optical fiber. However, if the foreign materials are strongly adhered to the optical fiber due to the lapse of time, blowing of gas is not able to remove them. Although the optical fiber is brought into an atmosphere containing an electrostatic charge carrying material in the technique disclosed in Patent Document 2, it is not possible to completely remove the foreign material from the surface of the optical fiber since the foreign material on the surface of the optical fiber is not physically removed. In addition, the techniques disclosed in these Patent Documents require a gas and antistatic agent for removing the foreign material on the surface of the optical fiber and requires a large mechanism and apparatus for supplying such gas and antistatic agent, and maintenance thereof is troublesome.

In the technique disclosed in Patent Document 3, the time interval from the drawing of the optical fiber to its coloring is controlled for preventing the color layer from separating from the optical fiber. If the place and operator for conducting the drawing and subsequent protective coating is different from that for conducting secondary coating for coloring the optical fiber, control of the time interval is substantially impossible and is not practical.

Recently, the present inventors have found that if the protectively coated optical fiber is left to stand for an extended period of time, precipitate like finely divided particles may be formed on the protectively coated surface. It is deemed that some materials which is contained in the protective coating (usually made of an UV (ultra-violet)-curable resin) do not precipitate for a short period of time (for example, less than 1 year), but precipitate on the coated surface with lapse of an extended period of time. If a color layer is formed on the surface of the optical fiber having precipitate thereon, separation of the color layer is liable to occur.

If the detection of uneven spots on the surface of the optical fiber is set as a control item in the process for rewinding the optical fiber, the presence of the foreign material such as refuse or precipitate adhered to the optical fiber is erroneously detected as the uneven spot of the optical fiber. Although the foreign material may be removed actually by wiping and is not unusual essentially, the foreign material may cause erroneous detection so that normal optical fiber may be detected as irregular optical fiber. Frequent erroneous detections may increase working for cutting and removing the optical fiber or reinspection, resulting in lowering of the productivity, and an increased cost.

In light of foregoing, there is disclosed a method and apparatus for producing an optical fiber which is capable of producing the optical fiber having a high reliability by directly wiping the surface of the optical fiber with cleaning means for positively removing foreign materials adhered to or precipitated on the surface of the optical fiber and in which its facility is simple in structure and easy to maintain it.

In the method of producing an optical fiber according to the present invention, a cleaning member is disposed on an optical fiber moving path. The surface of moving optical fiber is cleaned by bringing the optical fiber into a physical contact with the cleaning member. The cleaning member can be formed of a porous or mesh member. The mesh member is formed of fiber sheets which are formed by knitting fiber threads. A plurality of fiber sheets are laminated to provide a given lamination thickness for the cleaning length of the optical fiber. On the other hand, the cleaning member is electrically grounded. The optical fiber is passed through the cleaning member prior to detection of uneven spots on the optical fiber. In case of coloring the optical fiber, the optical fiber is passed through the cleaning member prior to coloring.

In accordance with the present invention, foreign materials such as refuse or precipitate which is adhered to the surface of the optical fiber can be effectively removed by wiping the surface of the optical fiber with a cleaning member, which enables reliable optical fibers to be produced. Cleaning is achieved by a simple porous or mesh member which can be brought into a physical contact with the surface of the optical fiber. Necessity of large facility and maintenance can be eliminated.

### BRIEF DESCRIPTION OF THE DRAWINGS

FIGS. 1A to 1D are schematic views explaining the summary of the present invention;

FIG. 2 is a view showing an example in which the mesh member of the present invention is formed of a fiber sheet;

FIG. 3 is a table showing measurement results of erroneous detections of the uneven spots of optical fibers when using different cleaning members;

FIGS. 4A and 4B are views explaining the relation between the fiber sheet and separation of the color layer from the optical fiber;

FIGS. 5A and 5B are views explaining the relation between the fiber sheet and the cleaning length of the optical fiber;

FIG. 6 is a view showing an example in which the present invention is applied to an optical fiber rewinding apparatus;

FIG. 7 is a view showing an example in which the present invention is applied to the optical fiber coloring apparatus; and

FIGS. 8A through 8C are views showing the arrangement examples of the cleaning unit according to the present invention.

### PREFERRED EMBODIMENT OF THE INVENTION

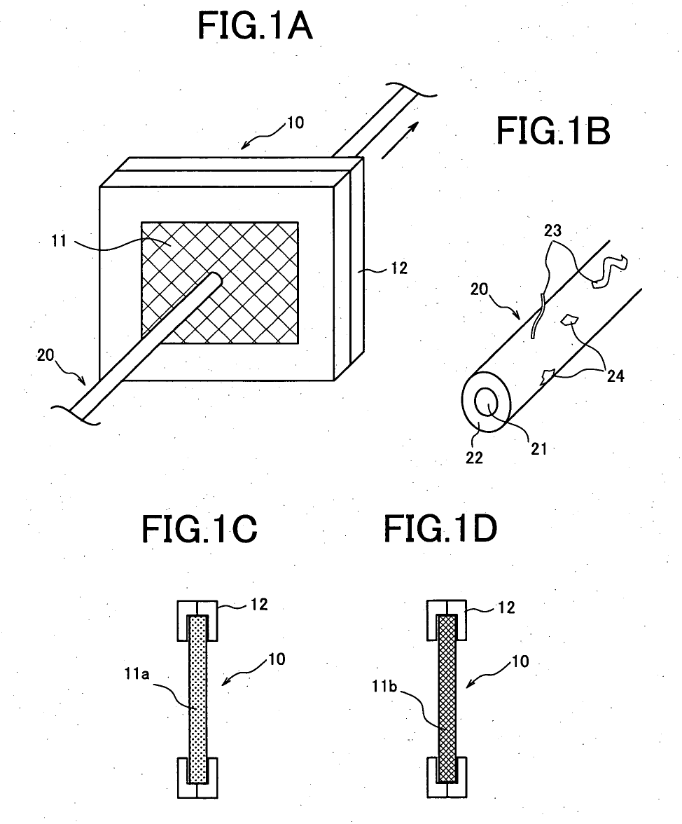

The present invention will be briefly described with reference to the drawings. FIG. 1A is a view explaining the cleaning step for an optical fiber of the present invention. FIG. 1B is a view showing the condition of the optical fiber. FIG. 1C is a view showing an example in which a cleaning member is formed of a porous member. FIG. 1D is a schematic view showing an example in which a cleaning member is formed of a mesh member. In the drawings, a reference numeral 10 denotes a cleaning unit; 11 a cleaning member; 11a a porous member; 11b a mesh member; 12 a holding frame; 20 optical fiber; 21 a glass fiber; 22 a protective coating; 23 dusts; and 24 precipitates.

As shown in FIG. 1A, the present invention provides a method of manufacturing an optical fiber comprising the steps of disposing a cleaning member 11 on a moving path of the optical fiber, bringing the cleaning member 11 into a physical contact with the surface of the moving optical fiber 20 and wiping the surface of the optical fiber 20 to remove foreign materials which are adhered thereon. As shown in FIG. 1B, the optical fiber 20 is a glass fiber comprising a core and a clad thereon, which is coated on the outer periphery thereof with a protective coating 22 made of an UV-curable resin and the like. The protective coating 22 is usually applied to the glass fiber 22 immediately after it has been drawn from heated and molten fiber matrix and the protective coating 22 is a single- or double-layered.

The glass fiber 21 has an outer diameter of 125 μm which meets the normal standards. The protective coating 22 is applied immediately after the drawing of the glass fiber 21 so that the coating has an outer diameter of about 250±15 μm. The coated optical fiber may be referred to as “optical element fiber”. The term “optical fiber” used herein refers to the optical element fiber which is coated with the protective coating 22 which is applied immediately after the drawing of the fiber, unless otherwise specified.

After the drawing, the optical fiber 20 is taken up by a reel and then rewinding may be conducted after measurement of the length of the fiber is conducted for dividing it into a predetermined length, or it may be subjected to second coating and coloring. A plurality of the optical fibers may be bundled into multi-core optical cable and optical tape core wire. In this process, refuse 23 such as dusts and particles are adhered to the surface of the optical fiber 20 when the optical fiber 20 is run out from a supply reel to move through guide rollers and the like. Since the optical fiber 20 is formed of an insulator such as glass and an UV-curable resin, it is liable to be electrostatically charged so that refuse 23 is ready to adhere thereto. Further, after the lapse of an extended period of time since the drawing of the optical fiber 20, very small powdery precipitates 24 may be formed on the surface of the optical fiber.

As mentioned above, the present invention contemplates removing foreign materials such as the refuse 23 and the precipitate 24 adhered to the surface of the optical fiber 20 by means of a cleaning member 11 in the course of the treating process of the optical fiber in various forms to prevent the subsequent steps from being adversely influenced. Some foreign materials which are adhered to the surface of the optical fiber may be easily removed only by blowing gas thereon as is disclosed in Patent Document 1 while the other foreign materials are hard to be removed due to high adhesion power therebetween. In particular, the precipitate 24 often can not be removed by blowing of the gas. Therefore, in accordance with the present invention, removing of the foreign materials is conducted by physically wiping the surface of the optical fiber with the cleaning member 11.

Accordingly, it is necessary to use as the cleaning member 11 a flexible member which is softer than the protective coating 22 so that the protective coating 22 of the optical fiber 20 is not damaged. As an example of the member, sponge-like porous member 11a may be used as shown in FIG. 1C. The porous member 11a may be formed of, for example, rubber, polyurethane, polyethylene, acryl, nylon, vinyl chloride, or mixtures thereof, or various synthetic foamed materials, or natural materials.

As more preferable cleaning member 11, the mesh member 11b may be used as shown in FIG. 1D. The mesh member 11b may be formed by making a mesh of fibers of composite material of nylon, acryl, polyurethane, silk, cotton or any other various synthetic resins or natural materials. The holding frame 12 is formed of a material having a high rigidity such as metal (iron, stainless-steel, aluminum, copper and the like) or synthetic resin (Teflon (trademark), vinyl chloride, acryl, polypropylene, polyethylene and the like).

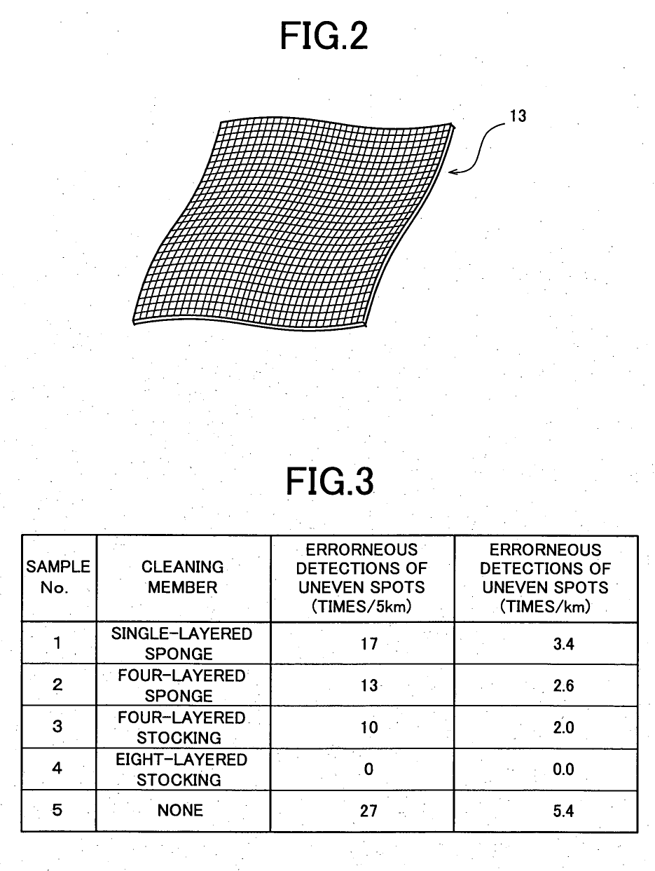

FIG. 2 is a view showing an example in which the mesh member of FIG. 1D is formed of a fiber sheet 13. The fiber sheet 13 may be, for example, a material which is used as stocking material. Since the stocking material has both the stretchability and flexibility, economical mesh member can be produced by laminating a necessary number of sheets of the stocking material which are cut into a suitable size.

A result of erroneous detection of the uneven spots on the optical fiber is shown in FIG. 3. The number of the uneven spots on the optical fiber is conducted after the optical fiber having a total length of 5 km has been cleaned using sheet-like sponge and stocking as the cleaning member. Thereafter the erroneous detection is measured. Sample No. 5 is shown for comparison when no cleaning member is used. For sample No. 5, the erroneous detections of the uneven spots are 27 (5.4/km). In contrast to this, when the sample No. 1 (single-layered sponge) is used as the cleaning member, the erroneous detections are 17 (3.4/km) When the sample No. 2 (4-layered sponge) is used, the erroneous detections are 13 (2.6/km). When the sample No. 3 (4-layered stocking) is used, the erroneous detections are 10 (2.0/km). When the sample No. 4 (8-layered stocking) is used, the erroneous detections are zero.

The result of FIG. 3 shows that cleaning of the surface of the optical fiber with a porous member such as sponge material or mesh member such as stocking member is apparently effective for removing foreign materials away from the surface of the optical fiber. Comparison of the result of the sample No. 2 with that of the sample No. 3 shows that the mesh member such as stocking is more effective than the porous member such as sponge material to remove the foreign materials. It is apparent that layered structure using a plurality of sheets of these members can enhance the cleaning effect.

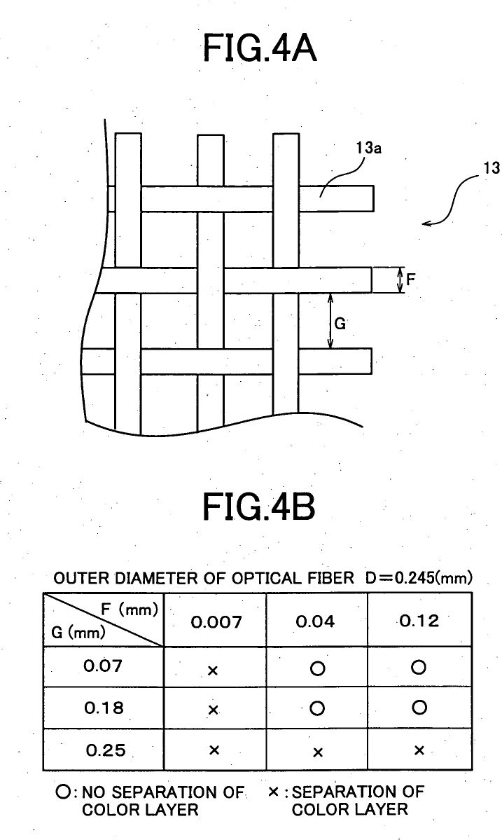

Studying on how the effectiveness of the cleaning for the optical fiber changes depending upon the diameter of the fiber and the mesh size is conducted when fiber sheet such as stocking is used. As shown in FIG. 4A, the diameter of the fiber thread 13a of the fiber sheet 13 is represented by F (mm) and the mesh size of the fiber threads 13a is represented by G (mm). The outer diameter of the optical fiber (the outer diameter of the protective coating) which is threaded through the fiber sheet 13 is represented by D. Cleaning of the optical fiber having D=0.245 mm and a length of 5 km is repeatedly conducted for the changed mesh sizes G and fiber thread diameters F. Color layers of color paints are formed on the cleaned surfaces of the respective optical fibers. Strippability of the color layers from the surface of the optical fibers is researched.

The result of research in FIG. 4B shows that the color layers are separated from all optical fibers which are cleaned with the fiber sheet 13 made of fiber thread 13a having a diameter F of 0.007 mm and the color layers are separated from all optical fibers which are cleaned with the fiber sheet 13 made of fiber threads 13a having a mesh size G of 0.25 mm.

This result suggests that the fiber threads 13a having a very small diameter F provide a low wiping power so that cleaning action is not effective. Accordingly, it is preferable that the fiber threads 13a have a diameter F of about 0.01 mm or more. It is presumed that if the mesh size G of the fiber threads 13a is approximate to the outer diameter D of the optical fiber, the optical fiber passes through the mesh, so that the cleaning action is not effective. Accordingly, based upon the fact that no separation of the color layer occurs if the mesh size G is 0.18 mm or less, it is preferable that the mesh size G of the fiber threads 13a is substantially not higher than 80% of the outer diameter D of the optical fiber, that is, G=0.8×D.

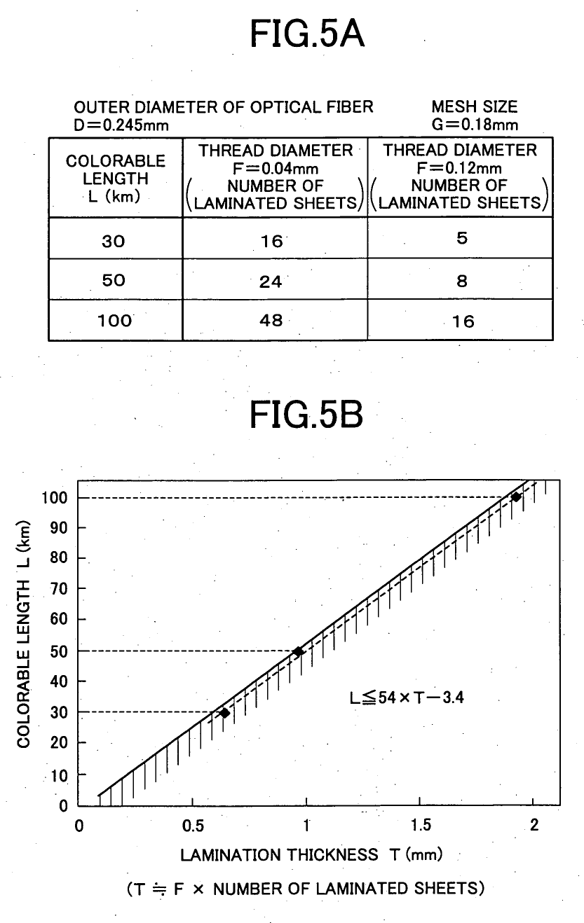

The length of the optical fiber in which no separation of the color layer occurs when the optical fiber is colored after cleaning is represented by “colorable length L (km)”. The relation between the colorable length L and the number of the laminated fiber sheets is studied. FIG. 5A shows the relation between the colorable length L and the number of the laminated fiber sheets. FIG. 5B is a graph showing the relation between the colorable length L and the thickness of the laminated fiber sheets T which is converted from the number of the laminated fiber sheets. It should be noted that in this test, the tested optical fiber has an outer diameter D which is fixed to a constant, 0.245 mm. Based upon the result of FIG. 4B, the mesh size G of the fiber sheets is fixed to a constant, 0.18 mm and the diameter of the fiber thread F is 0.04 mm and 0.12 mm. The thickness T of the laminated fiber sheets is represented by a relation “the diameter of the fiber thread F×the number of the laminated sheets”.

In accordance with the relation shown in FIG. 5A, if the colorable length L is 30 km, the number of the necessary laminated fiber sheets is 16 and 5 for the fiber threads having a diameter F of 0.04 mm and 0.12 mm, respectively, which number can be converted into the thickness T of the laminated sheets, 0.64 and 0.6 mm, respectively. If the colorable length L is 50 km, the number of the necessary laminated fiber sheets is 24 and 8 for the fiber thread having a diameter of 0.04 mm and 0.12 mm, respectively. The number can be converted into a thickness T of 0.96 mm. If the colorable length L is 100 km, the number of the necessary laminated fiber sheets is 48 and 16 for the diameter F of the fiber thread of 0.04 mm and 0.12 mm, respectively, which number can be converted into 1.92 mm.

As shown in FIG. 5B, it is found from the above-mentioned test result that the relation between the colorable length L and the thickness T of the laminated sheets can be represented by a first-degree equation “L=54×T−3.4”. Therefore, the specifications such as the thickness of the laminated fiber sheets (the number of laminated sheets) which are used for cleaning the optical fibers prior to coloring can be easily preset if the length of the optical fiber (colorable length L) to be colored is determined based upon the above-mentioned equation. In other words, if the length of the optical fiber which is positively subjected to cleaning is represented by L, it is preferable that cleaning should be conducted by using the fiber sheets having a lamination thickness (the number of laminated fiber sheets) which satisfies the above-mentioned first-degree equation.

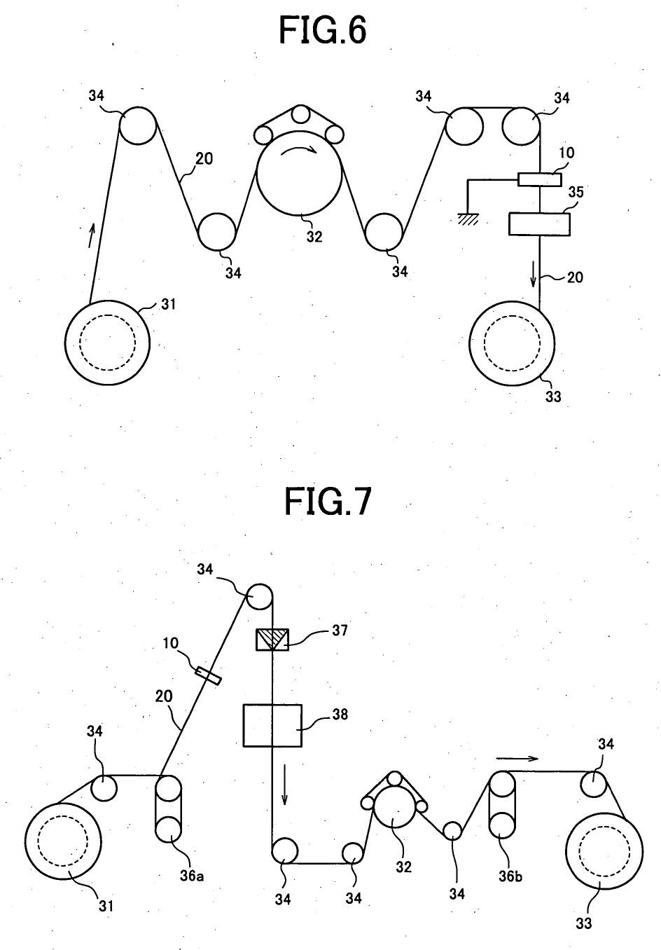

FIG. 6 is a view showing an example in which the present invention is applied when the optical fiber is rewound. FIG. 7 is a view showing an example in which the present invention is applied when the optical fiber is colored. In the drawings, a reference numeral 10 denotes a cleaning unit; 20 an optical fiber; 31 a supply reel; 32 a capstan roller; 33 a take-up reel; 34 guide rollers; 35 an optical fiber uneven spot detector; 36a a supply dancer roller; 36b a take-up dancer roller; 37 a coloring dies; and 38 an UV-curable device.

The optical fiber 20 is coated with a protective coating layer which is formed when the fiber is drawn and is referred to as “optical element fiber” which is not subsequently coated with second coating or is not colored. The cleaning unit 10 includes a cleaning member which has been described with reference to FIGS. 1A to 5B. The cleaning unit 10 is disposed on a moving path of the optical fiber 20 so that it is brought into a direct and physical contact with the surface of the moving optical fiber 20 for wiping it to remove foreign materials such as refuse and/or precipitate adhered upon the surface of the optical fiber. The cleaning unit 10 can be electrically grounded as shown in the drawing for removing the electrostatic charges on the optical fiber 20. In order to provide the optical fiber 20 with antistatic properties, the cleaning member of the cleaning unit 10 may be formed of an antistatic material or an antistatic agent may be applied or sprayed upon the cleaning member, so that the member contains the antistatic.

The optical fiber rewinding apparatus which is shown in FIG. 6 is used for rewinding the optical fiber from a long fiber winding reel which have wound the drawn fiber onto a predetermined length fiber winding reel for shipping. The rewinding operation is usually conducted by pulling the optical fiber 20 which has been run out from the supply reel 31 via several guide rollers 34 by means of a capstan roller 32 and by taking up it via several guide rollers 34 by means of the take-up reel 33. In this case, the uneven spot detector 35 for optically detecting a defect on the coated surface of the optical fiber 20 is provided upstream of the take-up reel 33. The cleaning unit 10 of the present invention is disposed upstream of the uneven spot detector 35.

The cleaning unit 10 may be disposed in any position if it is on the moving path of the optical fiber. For detecting the uneven spot of the optical fiber 20, it is preferable that the cleaning unit 10 is disposed at a short distance in an atmosphere before the uneven spot detector 35 in which no foreign material will adhere to the optical fiber 20 in a path between the cleaning unit 10 and the uneven spot detector 35. As a result, erroneous detection of the uneven spots can be prevented as described with reference to FIG. 3. The detection accuracy is dependent upon the material of the cleaning member and the lamination amount as mentioned above.

The coloring apparatus for the optical fiber shown in FIG. 7 is, for example, used for distinguishing the optical fiber by applying coloring paint or ink in a few μm thickness to the surface of the optical fiber which is rewound after the drawing. In this coloring operation, the tension of the optical fiber run out from the supply reel 31 is usually adjusted with several guide rollers 34 and supply dancer roller 36a. Then, the surface of the optical fiber is colored with coloring dyes 37 and the colored layer is cured with the UV-curable device 38 and the like. Then, the optical fiber having the colored layer is taken back with the capstan roller 32 via several guide rollers 34. After the tension adjustment is conducted with the take-up dancer roller 36b, the optical fiber is taken up with the take-up reel 33.

In the present invention, for coloring the optical fiber, the optical fiber 20 is passed through the cleaning unit 10 prior to passing through a coloring die 37. Since the cleaning unit 10 removes foreign materials adhered to the surface of the optical fiber prior to the formation of the color layer on the surface of the optical fiber, so that colored optical fiber from which no color layer is separated can be produced as described with reference to FIGS. 4A through 5B. In particular, since a precipitate from the protective coating may be precipitated and adhere thereto if an extended period of time has lapsed since the drawing of the optical fiber 20, the cleaning unit 10 is very effective to remove these foreign materials.

It should be noted that the cleaning unit 10 is disposed in the coloring apparatus in FIG. 7. Alternatively, the optical fiber may be colored by means of the coloring apparatus of FIG. 7 after the optical fiber is cleaned and is taken up by the take-up reel in the rewinding apparatus of FIG. 6. If the time interval between the cleaning and coloring of the optical fiber becomes longer, readhesion of the dusts and precipitate may occur. It is thus preferable to make the interval therebetween as short as possible. However, since it is possible to separate the cleaning operation from the coloring operation, this means is very effective in case the operation positions and operators are different.

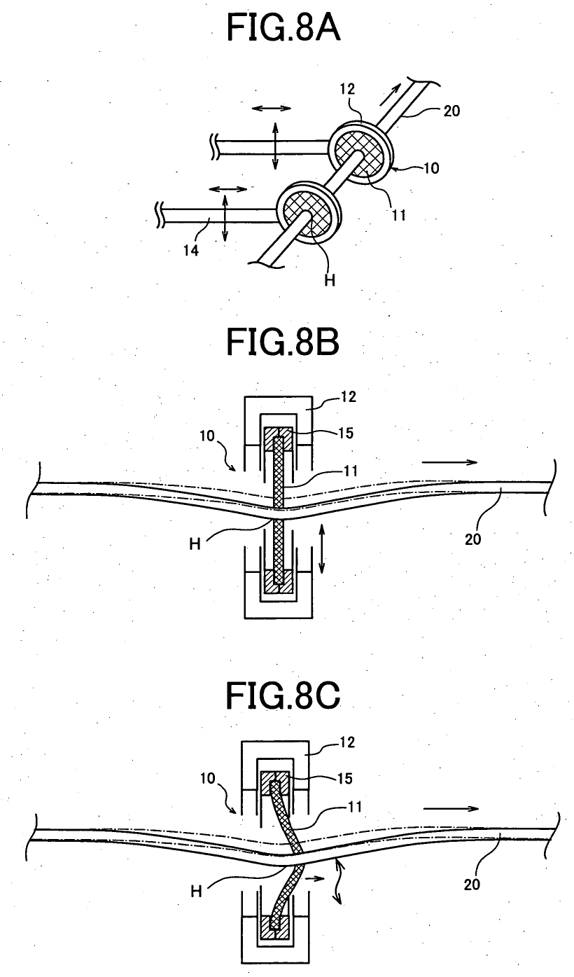

FIG. 8A is a view showing an example in which the cleaning unit is disposed. FIGS. 8B and 8C are views showing the other examples in which the cleaning members are disposed. In the drawings, a reference numerals 14 and 15 denote a supporting arm and mounting head, respectively. Since other numerals which are identical to those in FIG. 1A denote identical parts, description of them will be omitted.

As shown in FIG. 8A, the cleaning unit 10 comprises the cleaning member 11 which is held by a holding frame 12. The holding frame 12 is disposed in a suitable mechanism portion on a moving path of the optical fiber 20 by means of a supporting arm 14. The cleaning unit 10 may be divided into a plurality of portions, which are disposed in different positions. The optical fiber 20 is preferably passed through the central portion of the cleaning member 11, so that it is brought into a direct and physical contact with the cleaning member 11 at the optical fiber insertion portion H for wiping. The optical fiber 20 is moved along a predetermined path line at a predetermined tension in a steady condition whereas the path line may change due to variations of such as linear tension of the optical fiber. The position of the optical fiber insertion portion H of the cleaning member 11 may be offset relative to the path line of the optical fiber 20.

In this case, if the cleaning member 11 is fixed, the cleaning member 11 is not uniformly contacted with the outer periphery of the optical fiber 20, so that some of the outer periphery of the optical fiber 20 may not be in contact with the cleaning member. As a result, wiping over the surface of the optical fiber may not uniformly conducted, so that removal of the foreign material becomes incomplete. Hence, it is preferable that the position of the optical fiber insertion portion H of the cleaning unit 10 is adjustable in response to the changes in position of the path line of the optical fiber 20. It is also preferable that the position of the optical fiber insertion portion H is movable so that it is self-aligned with the position of normally moving optical fiber by the linear tension of the optical fiber.

For example, it is assumed that the path line of the optical fiber 20 changes due to changes in linear tension of the optical fiber 20 as shown in FIG. 8A. It is preferable that the holding position of the cleaning member 11 can be adjusted by controlling the supporting arm 14 in an upward or downward direction or left or right direction so that the contact condition between the cleaning member 11 and the optical fiber 20 at the optical fiber insertion portion H is kept at a steady contact condition even if the path line changes. Drive control of the support arm 14 can be conducted by detecting the path line of the optical fiber by means of sensor. If the linear tension of the optical fiber is used, the drive control may be conducted by using a mechanism which enables the support arm 14 to be moved in an upward or downward direction or left or right direction with a less moving resistance.

FIG. 8B shows an exemplary structure in which the mounting head 15 for mounting the cleaning member 11 is held relative to the holding frame 12 by the low frictional resistance and is movably self-aligned by the linear tension of the optical fiber. It is assumed that the path line of the optical fiber 20 changes from a dot and chain line to a solid line due to the variation in linear tension of the optical fiber 20. In this case, the cleaning member 11 becomes movable in a radial direction of the optical fiber 20 together with the optical fiber insertion portion H in response to the linear tension of the optical fiber 20. As a result, the contact condition between the optical fiber 20 and the cleaning member 11 at the optical fiber insertion portion H is kept in a steady state, so that uniform wiping manner can be maintained.

FIG. 8C shows an example in which a soft and flexible member is used for the cleaning member 11 and is mounted on the mounting head 15 in such a manner that it is slack. The optical fiber 20 is in a frictional contact with the cleaning member 11 at the optical fiber insertion portion H. Accordingly, if the cleaning member 11 is formed of a soft and flexible member such as rubber, the optical fiber insertion portion H of the cleaning member 11 is shifted in an optical fiber moving direction due to the friction between the optical fiber and the member 11 caused by the movement of the optical fiber. The cleaning member 11 is allowed to slightly move in a radial direction due to the flexibility of the cleaning member 11. As a result, the contact condition between the optical fiber 20 and the cleaning member 11 at the optical fiber insertion portion H is kept in a steady state, so that uniform wiping can be maintained. Although this example is not suitable for the case in which the path line of the optical fiber 20 is largely changed, the range of shift can be increased by combining this structure with those in FIGS. 8A and 8B.

Alternatively, the cleaning member 11 may be mounted on the mounting head 15 in such a manner that it is slack. For example, it is assumed that the path line of the optical fiber 20 changes from a dot and chain line to a solid line. At this time, the optical fiber insertion portion H of the cleaning member 11 is relatively readily movable in a moving and radial direction due to the slack of the cleaning member 11 in response to the change in the position of the optical fiber 20. As a result, the contact condition between the optical fiber 20 and the cleaning member 11 at the optical fiber insertion portion H is kept in a steady state, so that uniform wiping can be maintained. Although this example is not suitable for the case in which the path line of the optical fiber 20 is largely changed, the range of shift can be increased by combining this structure with those in FIGS. 8A and 8B.

1. A method of producing an optical fiber comprising:
disposing a cleaning member on an optical fiber moving path, and
bringing a surface of the moving optical fiber into a physical contact with the cleaning member for cleaning the surface of the moving optical fiber.

2. A method of producing an optical fiber as defined in claim 1, wherein the cleaning member is formed of a porous member.

3. A method of producing an optical fiber as defined in claim 1, wherein the cleaning member is formed of a mesh member.

4. A method of producing an optical fiber as defined in claim 3, wherein the mesh member is formed of a fiber sheet which is formed by knitting fiber threads and the optical fiber is inserted into an interstice of the fiber sheet.

5. A method of producing an optical fiber as defined in claim 4, wherein the fiber sheet satisfies the relation F=0.01 (mm) and G=0.8×D in which D denotes the outer diameter of the optical fiber, G denotes the mesh size of the fiber thread and F denotes the diameter of the fiber thread.

6. A method of producing an optical fiber as defined in claim 4, wherein a plurality of fiber sheets are laminated in a moving direction of the optical fiber.

7. A method of producing an optical fiber as defined in claim 6, wherein the number of the laminated fiber sheets is preset to establish the relation “L=54×T−3.4” in which L (km) denotes the length of the optical fiber to be cleaned and T (mm) denotes the thickness of the laminated fiber sheets.

8. A method of producing an optical fiber as defined in claim 1, wherein the cleaning member is electrically grounded.

9. A method of producing an optical fiber as defined in any one of claims 1 through 8, wherein the optical fiber is passed through the cleaning member prior to detection of uneven spots on the optical fiber.

10. A method of producing an optical fiber as defined in any one of claims 1 through 8, wherein the optical fiber is passed through the cleaning member prior to coloring of the optical fiber.

11. A method of producing an optical fiber as defined in claim 10, wherein after the optical fiber is passed through the cleaning member, the optical fiber is taken up on a reel and then is subjected to coloring.

12. An apparatus for producing an optical fiber, wherein a cleaning member is disposed on an optical fiber moving path so that the cleaning member is brought into a physical contact with the surface of the moving optical fiber for cleaning the surface thereof.

13. An apparatus for producing an optical fiber as defined in claim 12, wherein the cleaning member is held so that the contact portion of the cleaning member and the optical fiber is movable to a position of normally moving optical fiber by the movement of the optical fiber.

14. An apparatus for producing an optical fiber as defined in claim 12, wherein the cleaning member is elongated due to friction between the cleaning member and the optical fiber so that the contact portion of the cleaning member and the optical fiber is movable in a moving direction of the optical fiber.

15. An apparatus for producing an optical fiber as defined in claim 12, wherein the cleaning member is held to have such a slack that the contact portion which is in a contact with the optical fiber is movable in a moving and radial direction of the optical fiber due to the movement of the optical fiber.

16. An apparatus for cleaning an optical fiber, wherein cleaning member is disposed on an optical fiber moving path so that it is brought into a physical contact with the surface of the moving optical fiber for cleaning the surface thereof.

17. An apparatus for cleaning an optical fiber as defined in claim 16, wherein the cleaning member is held so that the contact portion of the cleaning member is movable to a position of normally moving optical fiber by the movement of the optical fiber.

18. An apparatus for cleaning an optical fiber as defined in claim 16, wherein the cleaning member is elongated due to friction between the cleaning member and the optical fiber so that the contact portion of the cleaning member and the optical fiber is movable in a moving direction of the optical fiber.

19. An apparatus for cleaning an optical fiber as defined in claim 16, wherein the cleaning member is held to have such a slack that the contact portion which is in a contact with the optical fiber is movable in a moving and radial direction of the optical fiber due to the movement of the optical fiber.
